(19) United States
(12) Patent Application Publication
(10) Pub. No.: US 2026/0275026 A1
(43) Pub. Date: Sep. 17, 2026

(54) CONDUCTIVE COMPOSITION

(71) Applicant: TATSUTA ELECTRIC WIRE & CABLE CO., LTD., Osaka (JP)

(72) Inventor: Junpei FUKANO, Kyoto (JP)

(21) Appl. No.: 19/162,824

(22) PCT Filed: Mar. 7, 2024
(86) PCT No.: PCT/JP2024/008672

§ 371 Date: Sep. 5, 2025

(30) Foreign Application Priority Data
Mar. 9, 2023 (JP) 2023-036338

(51) Int. Cl. C08G 59/62; C08K 5/3445

(52) U.S. Cl. CPC C08G 59/621; C08K 5/3445; C08K 2201/001

(57) ABSTRACT

A conductive composition contains an epoxy compound, an imidazole compound, a phenolic curing agent and conductive particles. In the epoxy compound, a content percentage of a naphthalene skeleton-containing epoxy resin is 10 to 30% by mass, a content percentage of a glycidylamine-based epoxy resin is 40 to 90% by mass, and a content percentage of a reactive diluent having one to two glycidylether functional groups in an aliphatic hydrocarbon chain is 10% by mass or less. The imidazole compound contains at least one selected from the group consisting of 2-undecylimidazole, 2-heptadecylimidazole, 4-methyl-2-phenylimidazole and 2-phenyl-4-methyl-5-hydroxymethylimidazole. Based on 100 parts by mass of the epoxy compound, the imidazole compound content is three to 10 parts by mass, and the phenolic curing agent content is 10 to 20 parts by mass. The conductive particle content is 82 to 90% by mass in the conductive composition.

### TECHNICAL FIELD

The present invention relates to a conductive composition.

### BACKGROUND ART

In electronic devices such as mobile phones and tablet devices, with the reduction in size and the improvement of performance of semiconductor devices and chip parts, it has been recently required to mount many electronic parts highly densely, and the demand for a multilayer substrate is further growing.

To electrically connect the layers in a multilayer substrate, a method of forming a via which goes through the layers and filling the via with a conductive paste is used. As such a conductive paste, a conductive paste such as one described in PTL 1 is known.

Moreover, as a conductive adhesive for connecting the substrate and an electronic part, compositions such as those described in PTLs 2 and 3 are known.

In recent years, however, with the reduction in size and the improvement of performance of semiconductor devices and chip parts, the heat generation amounts of the semiconductor device and the chip part themselves have become high. Moreover, because heat treatment at 150° C. to 300° C. is repeated multiple times in the production process thereof, heat resistance in a high-temperature environment is required. Accordingly, a conductive composition which has both excellent conductivity and excellent adhesion in a high-temperature environment is desired.

### CITATION LIST

### Patent Literature

PTL 1: JP2005-302904A
PTL 2: JP2005-126658A
PTL 3: JP2009-001661A

### SUMMARY OF INVENTION

### Technical Problem

The invention has been made in view of the above points, and an object thereof is to provide a conductive composition having excellent conductivity and achieving excellent adhesion to a substrate in a high-temperature environment.

### Solution to Problem

The invention includes the embodiments shown below.

[1] A conductive composition containing an epoxy compound, an imidazole compound, a phenolic curing agent and conductive particles
in which in the epoxy compound, a content percentage of a naphthalene skeleton-containing epoxy resin is 10 to 30% by mass, a content percentage of a glycidylamine-based epoxy resin is 40 to 90% by mass, and a content percentage of a reactive diluent having one to two glycidylether functional groups in an aliphatic hydrocarbon chain is 10% by mass or less,
the imidazole compound contains at least one selected from the group consisting of 2-undecylimidazole, 2-heptadecylimidazole, 4-methyl-2-phenylimidazole and 2-phenyl-4-methyl-5-hydroxymethylimidazole,
a content of the imidazole compound is three to 10 parts by mass based on 100 parts by mass of the epoxy compound,
a content of the phenolic curing agent is 10 to 20 parts by mass based on 100 parts by mass of the epoxy compound, and
a content of the conductive particles is 82 to 90% by mass in the conductive composition.
[2] The conductive composition according to [1] in which a glass transition temperature of a cured material obtained by heating at 80° C. for 30 minutes and then heating at 180° C. for 60 minutes is 150° C. or higher.

### Advantageous Effects of Invention

According to the conductive composition of the invention, excellent conductivity and excellent adhesion to a substrate in a high-temperature environment are obtained.

### BRIEF DESCRIPTION OF DRAWINGS

FIG. 1 A side view and a front view schematically illustrating test pieces used for evaluating the adhesion.

### DESCRIPTION OF EMBODIMENTS

The conductive composition according to the invention contains an epoxy compound, an imidazole compound, a phenolic curing agent and conductive particles and is a thermosetting conductive composition.

The epoxy compound contains a naphthalene skeleton-containing epoxy resin and a glycidylamine-based epoxy resin and optionally contains a reactive diluent having one to two glycidylether functional groups in an aliphatic hydrocarbon chain. That is, the reactive diluent is not an essential component and does not have to be contained.

As the naphthalene skeleton-containing epoxy resin, one having an epoxy group and a naphthalene skeleton in the molecule can be used, and examples thereof include epoxy resins having a naphthalene skeleton such as naphthalene-type epoxy resin, dihydroxynaphthalene-type epoxy resin, polyhydroxy binaphthalene-type epoxy resin, naphthol-type epoxy resin, binaphthol-type epoxy resin, naphthylene ether-type epoxy resin, naphthol novolac-type epoxy resin and a naphthalene-type epoxy resin obtained through condensation reaction of polyhydroxynaphthalene and an aldehyde and the like. Any one kind thereof may be used, or two or more kinds thereof may be used in combination. Examples of the commercial product of the naphthalene skeleton-containing epoxy resin include “EPICLON HP-4700”, “EPICLON HP-4710”, “EPICLON HP-5000” and “EPICLON HP-6000” manufactured by DIC Corporation, “NC-7000-L” and “NC-7300-L” manufactured by Nippon Kayaku Co., Ltd. and the like.

The epoxy equivalent of the naphthalene skeleton-containing epoxy resin is not particularly limited but is preferably 160 to 260 g/eq, more preferably 160 to 240 g/eq.

As the glycidylamine-based epoxy resin, an epoxy resin containing at least one glycidylamino group can be used, and the glycidylamino group contains one epoxy group. Examples of such a compound include tetraglycidyldiamino phenylmethane-type epoxy resin, tetraglycidyldiamino diphenylmethane-type epoxy resin, triglycidylamino phenol-type epoxy resin and the like. Any one kind thereof may be used, or two or more kinds thereof may be used in combination. Examples of the commercial product of the glycidylamine-based epoxy resin include “jER630” manufactured by Mitsubishi Chemical Group Corporation, “Epotohto YH-404” and “Epotohto YH-434L” manufactured by NIPPON STEEL Chemical & Material Co., Ltd., “SUMI-EPOXY ELM-434” and “SUMI-EPOXY ELM-100” manufactured by Sumitomo Chemical Co., Ltd., “EP-3950S” manufactured by ADEKA CORPORATION and the like.

The epoxy equivalent of the glycidylamine-based epoxy resin is not particularly limited but is preferably 90 to 120 g/eq, more preferably 90 to 110 g/eq.

As the reactive diluent, a compound having one or two glycidylether functional groups in an aliphatic hydrocarbon chain can be used. The aliphatic hydrocarbon chain preferably has three to 13 carbon atoms, more preferably six to 13 carbon atoms. Examples of such a compound include “ADEKA Glycirol ED-502” and “ADEKA Glycirol ED-503G” manufactured by ADEKA CORPORATION, “YEDlllN” and “YED216M” manufactured by Mitsubishi Chemical Group Corporation, “DY-BP”, “EPOGOSEY (registered trademark) BD(D)”, “EPOGOSEY (registered trademark) NPG(D)” and “EPOGOSEY (registered trademark) HD(D)” of Yokkaichi Chemical Co., Ltd. and the like.

The epoxy equivalent of the reactive diluent is not particularly limited but is preferably 100 to 320 g/eq, more preferably 100 to 150 g/eq.

As long as the effects of the invention are not impaired, the epoxy compound may contain an epoxy compound other than naphthalene skeleton-containing epoxy resins, glycidylamine-based epoxy resins and the reactive diluent. Examples of such an epoxy compound include bisphenol A-type epoxy resin, bisphenol F-type epoxy resin, cresol novolac-type epoxy resin, phenol novolac-type epoxy resin, biphenyl-type epoxy resin, a triphenylmethane-type epoxy resin, dicyclopentadiene-type epoxy resin and the like.

The content percentage of the naphthalene skeleton-containing epoxy resin in the epoxy compound is 10 to 30% by mass, preferably 10 to 25% by mass, more preferably 15 to 25% by mass. When the content percentage of the naphthalene skeleton-containing epoxy resin is in the above range, the glass transition temperature (Tg) of the cured material obtained by heating the conductive composition at 80° C. for 30 minutes and then heating at 180° C. for 60 minutes is high, and excellent adhesion is obtained easily.

The content percentage of the glycidylamine-based epoxy resin in the epoxy compound is 40 to 90% by mass, preferably 60 to 80% by mass, more preferably 60 to 70% by mass. When the content percentage of the glycidylamine-based epoxy resin is in the above range, the glass transition temperature (Tg) of the cured material obtained by heating the conductive composition at 80° C. for 30 minutes and then heating at 180° C. for 60 minutes is high, and excellent adhesion is obtained easily.

The content percentage of the reactive diluent in the epoxy compound is 10% by mass or less, preferably 8% by mass or less, more preferably 0 to 5% by mass. When the content percentage of the reactive diluent is in the above range, the glass transition temperature (Tg) of the cured material obtained by heating the conductive composition at 80° C. for 30 minutes and then heating at 180° C. for 60 minutes is high, and excellent adhesion is obtained easily.

The epoxy equivalent of the epoxy compound is not particularly limited but is preferably 95 to 160 g/eq, more preferably 100 to 130 g/eq.

The imidazole compound contains at least one selected from the group consisting of 2-undecylimidazole, 2-heptadecylimidazole, 4-methyl-2-phenylimidazole and 2-phenyl-4-methyl-5-hydroxymethylimidazole. As long as the effects of the invention are not impaired, an imidazole compound other than those listed above may be contained, and examples of such an imidazole compound include imidazoles (for example, alkyl imidazoles such as 2-methylimidazole, 2-phenylimidazole and 2-ethyl-4-methylimidazole and aryl imidazoles such as 2-phenylimidazole, 2-phenyl-4-methylimidazole and 1-benzyl-2-phenylimidazole), salts of imidazoles (for example, organic salts such as formates, phenol salts and phenol novolac salts and salts such as carbonates) and the like.

The imidazole compound content, based on 100 parts by mass of the epoxy compound, is three to 10 parts by mass, preferably three to eight parts by mass, more preferably three to five parts by mass. When the imidazole compound content is three parts by mass or more, excellent conductivity is obtained easily, and when the content is 10 parts by mass or less, excellent adhesion is obtained easily.

The content percentage of 2-undecylimidazole, 2-heptadecylimidazole, 4-methyl-2-phenylimidazole and 2-phenyl-4-methyl-5-hydroxymethylimidazole in the imidazole compound is preferably 50 to 100% by mass, more preferably 70 to 100% by mass, further preferably 90 to 100% by mass.

Examples of the phenolic curing agent include: novolac-type phenolic resins such as phenol novolac resin, cresol novolac resin, tert-butylphenol novolac resin, nonylphenol novolac resin, naphthol novolac resin, trisphenol novolac resin and tetrakis phenol novolac resin; triphenol alkane-type phenolic resins such as triphenol methane-type resin and triphenol propane-type resin; aralkyl-type phenolic resins such as a phenol aralkyl resin having a phenylene skeleton, a diphenylene skeleton and/or the like, a naphthol aralkyl resin and a biphenyl aralkyl resin; polyhydroxystyrene resins such as poly(p-hydroxystyrene); and the like. Of these, the phenolic curing agent is preferably a naphthol aralkyl resin.

The phenolic curing agent content, based on 100 parts by mass of the epoxy compound, is 10 to 20 parts by mass, preferably 10 to 18 parts by mass, more preferably 10 to 15 parts by mass. When the phenolic curing agent content is in the above range, contact of powder is achieved due to cure shrinkage, and excellent conductivity is obtained easily.

The conductive particles are not particularly limited, but examples thereof include copper particles, silver particles, nickel particles, silver-coated copper particles, gold-coated copper particles, silver-coated copper alloy particles, silver-coated nickel particles, gold-coated nickel particles and the like. Any one kind thereof may be used, or two or more kinds thereof may be used in combination. Of these, the conductive particles are preferably at least one selected from the group consisting of copper particles, silver-coated copper particles and silver-coated copper alloy particles.

The silver-coated copper particles have copper particles and a silver layer or a silver-containing layer which coats at least a part of the copper particles. The silver-coated copper alloy particles have copper alloy particles and a silver layer or a silver-containing layer which coats at least a part of the copper alloy particles. The copper alloy particles contain 0.5 to 25% by mass of zinc and/or 0.5 to 30% by mass of nickel. The balance may be copper, and the copper as the balance may contain incidental impurities. The content percentage of the silver-containing layer in the silver-coated copper particles and the silver-coated copper alloy particles is not particularly limited but is preferably 4 to 24% by mass. The silver content of the silver-containing layer is not particularly limited but is preferably 90 to 100% by mass.

Moreover, the shape of the conductive particles may be spherical, flaky (scale-like), dendritic, fibrous or the like. Of these, conductive particles having a spherical or flaky (scale-like) shape are preferable. In this regard, the spherical shape includes not only a roughly true spherical shape (atomized powder) but also a roughly spherical shape such as a sphere of a roughly polyhedral shape (reduced powder) and an irregular shape (electrolytic powder).

The content percentage of the conductive particles in the conductive composition is 82 to 90% by mass, preferably 84 to 88% by mass, more preferably 84 to 86% by mass. When the content percentage of the conductive particles is 82% by mass or more, excellent conductivity is obtained easily, and when the content percentage is 90% by mass or less, excellent adhesion is obtained easily.

Moreover, the average particle size of the conductive particles is not particularly limited but is preferably 2 to 10 μm. When the average particle size of the conductive particles is 2 μm or more, the dispersibility of the conductive particles is excellent, aggregation can be prevented, and oxidation is not easily caused. When the average particle size of the conductive particles is 10 μm or less, excellent adhesion is obtained easily.

Here, in the present specification, the average particle size is the particle size of the number-based average particle size D50 (median diameter) measured by laser diffraction-scattering method.

The viscosity of the conductive composition may be appropriately adjusted according to the use, such as use for filling in a via formed in the layers of a multilayer substrate and use as an adhesive for a substrate and an electronic part, or according to the device used for filling or coating, but a general standard thereof is as follows. The measurement method of the viscosity is not limited, but for example, the viscosity can be measured using a conical plate-type rotational viscometer (so-called cone-plate viscometer).

When the viscosity is measured with a conical plate-type rotational viscometer, the viscosity measured using a cone spindle CP52 (cone angle: 3°, cone radius: 12 mm) of BROOK FIELD at a measurement temperature of 25° C. at 5 rpm is preferably 30 to 60 Pa-s, more preferably 30 to 50 Pa-s. When the viscosity is in the above range, excellent filling property in a via is obtained easily.

As long as the object of the invention is not impaired, a known additive, such as a defoaming agent, a thickener, a tackifier, a filler, a flame retardant and a colorant, can be added to the conductive composition of the invention.

In view of the adhesion, the glass transition temperature of a cured material obtained by heating the conductive composition of the invention at 80° C. for 30 minutes and then heating at 180° C. for 60 minutes is preferably 150° C. or higher, more preferably 170° C. or higher. In this regard, the upper limit of the glass transition temperature is not particularly limited and may be, for example, 250° C. Here, in the present specification, the glass transition temperature (Tg) is a value measured using a dynamic viscoelasticity analyzer “DMA242E Artemis” manufactured by NETZSCH Japan K.K. under the conditions of a frequency of 1 Hz, a dynamic load of 5 N, a static load of 1 N, a measurement temperature of 25 to 260° C. and a heating rate of 5° C./min. In this regard, the size of the cured material for measuring the glass transition temperature can be a length of 20 to 25 mm, a width of 4 to 5 mm and a thickness of 0.5 to 1.5 mm.

### EXAMPLES

The contents of the invention are explained in detail below based on Examples, but the invention is not limited to the contents described below. Moreover, “parts” or “%” below is based on mass unless otherwise particularly specified.

By blending and mixing components at the proportions shown in Tables 1 to 3, conductive compositions were obtained. The components used are as follows.
Naphthalene skeleton-containing epoxy resin 1: “HP-4710” manufactured by DIC Corporation, epoxy equivalent=170 g/eq
Naphthalene skeleton-containing epoxy resin 2: “NC-7000-L” manufactured by Nippon Kayaku Co., Ltd., epoxy equivalent=235 g/eq
Glycidylamine-based epoxy resin 1: “jER630” manufactured by Mitsubishi Chemical Group Corporation, epoxy equivalent=95 g/eq
Glycidylamine-based epoxy resin 2: “YH-434L” manufactured by NIPPON STEEL Chemical & Material Co., Ltd., epoxy equivalent=115 g/eq
Dicyclopentadiene-type epoxy resin: “EP-4088S” manufactured by ADEKA CORPORATION, epoxy equivalent=170 g/eq
Reactive diluent 1: “ED-503G” manufactured by ADEKA CORPORATION, carbon atom number of aliphatic hydrocarbon chain=6, epoxy equivalent=135 g/eq
Reactive diluent 2: “ED-502” manufactured by ADEKA CORPORATION, carbon atom number of aliphatic hydrocarbon chain=12 to 13, epoxy equivalent=320 g/eq
Imidazole compound 1: 2-undecylimidazole
Imidazole compound 2: 2-heptadecylimidazole
Imidazole compound 3: 4-methyl-2-phenylimidazole
Imidazole compound 4: 2-phenyl-4-methyl-5-hydroxymethylimidazole
Imidazole compound 5: 2,4-diamino-6-[2-(2-methyl-1-imidazolyl)ethyl]-1,3,5-triazine
Phenolic curing agent: naphthol-type phenolic resin, “MEH-7000” manufactured by Meiwa Plastic Industries. Ltd.
Conductive particles: silver-coated copper particles, average particle size=4 to 6 μm, spherical

The Examples and the Comparative Examples were evaluated as follows. The results are shown in Tables 1 to 3.

### (1) Specific Resistance

Lines (length of 60 mm, width of 1 mm and thickness of about 100 μm) of a conductive composition were printed on glass epoxy substrates, and the conductive composition was provisionally cured by heating at 80° C. for 30 minutes and then mainly cured by heating at 180° C. for 60 minutes. Thus, substrates for evaluation on which conductive patterns were formed were produced. Next, the resistance (R) between both ends of each conductive pattern was measured using a tester, and the specific resistance was calculated from the cross sectional area (S, cm²) and the length (L, cm) by the following equation (1). In this regard, five lines were printed on each of three glass epoxy substrates to form 15 conductive patterns in total, and the average of the specific resistance values thereof was determined. When the specific resistance was 2.5E-04 Ω·cm or less, the conductivity was evaluated to be excellent “A”. When the specific resistance was more than 2.5E-04 Ω·cm and 5.0E-04 Ω·cm or less, the conductivity was evaluated to be slightly excellent “B”. When the specific resistance was more than 5.0E-04 Ω·cm, the conductivity was evaluated to be poor “C”.

$$[ Math . 1 ]$$

$$Specific Resistance = ( S / L ) \times R \qquad ( 1 )$$

### (2) Glass Transition Temperature (Tg)

A conductive composition was provisionally cured by heating at 80° C. for 30 minutes and then mainly cured by heating at 180° C. for 60 minutes, and thus a cured material having a length of 25 mm, a width of 5 mm and a thickness of 1 mm was produced. The cured material was clamped with a dynamic viscoelasticity analyzer “DMA242E Artemis” manufactured by NETZSCH Japan K.K. with a chuck distance of 15 mm and measured under the conditions of a frequency of 1 Hz, a dynamic load of 5 N, a static load of 1 N, a measurement temperature of 25 to 260° C., a heating rate of 5° C./min and measurement mode of stress/strain mixed, and the peak value of tanδ was regarded as the glass transition temperature.

### (3) Adhesion

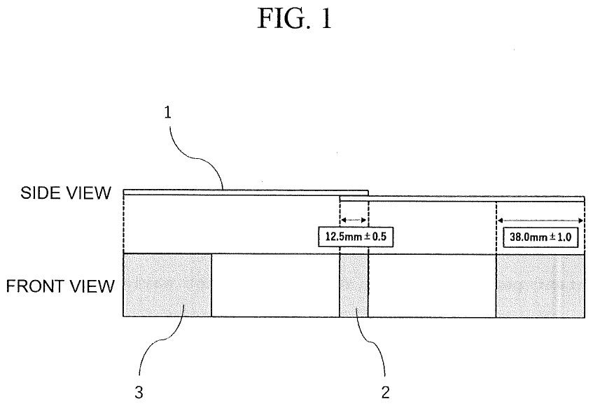

Tough pitch copper plates 1 defined in JIS H 3100 (length of 100 mm, width of 25 mm and thickness of 1.6 mm) are used. As illustrated in FIG. 1, a conductive composition was applied on a region of 12.5 mm±0.5 mm at an end of a tough pitch copper plate 1 (adhesion region 2), and two tough pitch copper plates were pasted. By provisionally curing by heating at 80° C. for 30 minutes and mainly curing by heating at 180° C. for 60 minutes, a test piece was produced. Using a tensile tester, as illustrated in FIG. 1, regions of 38.0 mm±1.0 mm at both ends of the test pieces (clamped regions 3) were clamped with the tensile tester, and tensile test was conducted. The maximum load applied until the test piece broke was measured, and the shear bond strength was determined by the following equation. When the shear bond strength was 5 MPa or more, the adhesion was evaluated to be excellent “A”. When the shear bond strength was 3 MPa or more and less than 5 MPa, the adhesion was evaluated to be slightly excellent “B”. When the shear bond strength was less than 3 MPa, the adhesion was evaluated to be poor “C”.

Shear Bond Strength (MPa)=Maximum Load (N)/Shear Area of Test Piece (mm²)

### (4) Adhesion in High-Temperature Environment

The evaluation was conducted in the same manner as in the evaluation of the adhesion above except for measuring in an environment at 150° C. In this regard, to adjust the test piece temperature to 150° C., the measurement was conducted 10 minutes after clamping the test piece with the tensile tester.

TABLE 1

| | | | | Comp. | | |
|---|---|---|---|---|---|---|
| | Ex. 1 | Ex. 2 | Ex. 3 | Ex. 1 | Ex. 4 | Ex. 5 |
| Naphthalene skeleton-containing | 10.0 | 10.0 | 10.0 | 10.0 | 10.0 | 10.0 |
| epoxy resin 1 | | | | | | |
| Glycidylamine-type epoxy | 60.0 | 60.0 | 60.0 | 60.0 | 60.0 | 60.0 |
| resin 1 | | | | | | |
| Dicyclopentadiene-type | 25.0 | 25.0 | 25.0 | 25.0 | 25.0 | 25.0 |
| epoxy resin | | | | | | |
| Reactive diluent 1 | 5.0 | 5.0 | 5.0 | 5.0 | 5.0 | 5.0 |
| Imidazole compound 1 | 3.0 | — | — | — | — | — |
| Imidazole compound 2 | — | 3.0 | 10.0 | 12.5 | — | — |
| Imidazole compound 3 | — | — | — | — | 3.0 | — |
| Imidazole compound 4 | — | — | — | — | — | 3.0 |
| Imidazole compound 5 | — | — | — | — | — | — |
| Phenolic curing agent | 10.0 | 10.0 | 10.0 | 10.0 | 10.0 | 10.0 |
| Conductive particles | 593.3 | 593.3 | 630.0 | 643.1 | 593.3 | 593.3 |
| Epoxy equivalent (g/eq) of | 114 | 114 | 114 | 114 | 114 | 114 |
| epoxy compound | | | | | | |
| Content percentage (% by mass) | 84.0% | 84.0% | 84.0% | 84.0% | 84.0% | 84.0% |
| of conductive particles in | | | | | | |
| conductive composition | | | | | | |
| Specific resistance (Ω · cm) | 2.5.E−04 | 3.0.E−04 | 1.0.E−04 | 9.0.E−05 | 3.8.E−04 | 3.7.E−04 |
| | A | B | A | A | B | B |
| Tg (° C.) of cured material | 166 | 162 | 171 | 171 | 178 | 181 |
| Adhesion (MPa) | 7.1 | 6.9 | 5.6 | 4.7 | 7.5 | 8.0 |
| | A | A | A | B | A | A |
| Adhesion (MPa) | 3.8 | 3.6 | 3.6 | 2.8 | 5.2 | 5.7 |
| (In environment at 150° C.) | B | B | B | C | A | A |

| | Comp. | | Comp. | | Comp. |
|---|---|---|---|---|---|
| | Ex. 2 | Ex. 6 | Ex. 3 | Ex. 7 | Ex. 4 |
| Naphthalene skeleton-containing | 10.0 | 10.0 | 10.0 | 10.0 | 10.0 |
| epoxy resin 1 | | | | | |
| Glycidylamine-type epoxy | 60.0 | 60.0 | 60.0 | 60.0 | 60.0 |
| resin 1 | | | | | |
| Dicyclopentadiene-type | 25.0 | 25.0 | 25.0 | 25.0 | 25.0 |
| epoxy resin | | | | | |
| Reactive diluent 1 | 5.0 | 5.0 | 5.0 | 5.0 | 5.0 |
| Imidazole compound 1 | — | — | — | — | — |
| Imidazole compound 2 | — | 3.0 | 3.0 | 3.0 | 3.0 |
| Imidazole compound 3 | — | — | — | — | — |
| Imidazole compound 4 | — | 3.0 | — | — | — |
| Imidazole compound 5 | 3.0 | — | — | — | — |
| Phenolic curing agent | 10.0 | 10.0 | — | 20.0 | 25.0 |
| Conductive particles | 593.3 | 609.0 | 540.8 | 645.8 | 672.0 |
| Epoxy equivalent (g/eq) of | 114 | 114 | 114 | 114 | 114 |
| epoxy compound | | | | | |
| Content percentage (% by mass) | 84.0% | 84.0% | 84.0% | 84.0% | 84.0% |
| of conductive particles in | | | | | |
| conductive composition | | | | | |
| Specific resistance (Ω · cm) | 3.5.E−02 | 3.6.E−04 | 4.7.E−03 | 3.3.E−04 | 3.4.E−04 |
| | C | B | C | B | B |
| Tg (° C.) of cured material | 195 | 178 | 155 | 170 | 173 |
| Adhesion (MPa) | 7.2 | 7.6 | 8.8 | 4.8 | 4.2 |
| | A | A | A | B | B |
| Adhesion (MPa) | 6.3 | 5.5 | 4.9 | 3.3 | 2.8 |
| (In environment at 150° C.) | A | A | B | B | C |

TABLE 2

| | Comp. | | |
|---|---|---|---|
| | Ex. 5 | Ex. 8 | Ex. 9 |
| Naphthalene skeleton-containing | 10.0 | 10.0 | 10.0 |
| epoxy resin 1 | | | |
| Glycidylamine-type epoxy resin 1 | 60.0 | 60.0 | 60.0 |
| Dicyclopentadiene-type epoxy | 25.0 | 25.0 | 25.0 |
| resin | | | |
| Reactive diluent 1 | 5.0 | 5.0 | 5.0 |
| Imidazole compound 2 | 3.0 | 3.0 | 3.0 |
| Phenolic curing agent | 10.0 | 10.0 | 10.0 |
| Conductive particles | 452.0 | 514.8 | 1017.0 |
| Epoxy equivalent (g/eq) of epoxy | 114 | 114 | 114 |
| compound | | | |
| Content percentage (% by mass) | 80.0% | 82.0% | 90.0% |
| of conductive particles in | | | |
| conductive composition | | | |
| Specific resistance | 7.8.E−04 | 4.0.E−04 | 2.1.E−04 |
| (Ω · cm) | C | B | A |
| Tg (° C.) of cured material | 162 | 162 | 162 |
| Adhesion (MPa) | 7.5 | 8.0 | 5.8 |
| | A | A | A |
| Adhesion (MPa) | 4.1 | 4.5 | 3.3 |
| (In environment at 150° C.) | B | B | B |

TABLE 3

| | Comp. | | | Comp. | | Comp. |
|---|---|---|---|---|---|---|
| | Ex. 6 | Ex. 10 | Ex. 11 | Ex. 7 | Ex. 12 | Ex. 8 |
| Naphthalene skeleton-containing | 10.0 | 10.0 | 10.0 | 5.0 | 30.0 | 35.0 |
| epoxy resin 1 | | | | | | |
| Naphthalene skeleton-containing | — | — | — | — | — | — |
| epoxy resin 2 | | | | | | |
| Glycidylamine-type epoxy resin 1 | 30.0 | 90.0 | — | 40.0 | 60.0 | 60.0 |
| Glycidylamine-type epoxy resin 2 | — | — | 60.0 | — | — | — |
| Dicyclopentadiene-type epoxy resin | 50.0 | — | 25.0 | 45.0 | 5.0 | — |
| Reactive diluent 1 | 10.0 | — | 5.0 | 10.0 | 5.0 | 5.0 |
| Reactive diluent 2 | — | — | — | — | — | — |
| Imidazole compound 2 | 3.0 | 3.0 | 3.0 | 3.0 | 3.0 | 3.0 |
| Phenolic curing agent | 10.0 | 10.0 | 10.0 | 10.0 | 10.0 | 10.0 |
| Conductive particles | 593.3 | 593.3 | 593.3 | 593.3 | 593.3 | 593.3 |
| Epoxy equivalent (g/eq) of epoxy compound | 135 | 99 | 131 | 127 | 114 | 114 |
| Content percentage (% by mass) of conductive | 84.0% | 84.0% | 84.0% | 84.0% | 84.0% | 84.0% |
| particles in conductive composition | | | | | | |
| Specific resistance (Ω · cm) | 2.4.E−04 | 3.4.E−04 | 2.5.E−04 | 4.8.E−04 | 2.3.E−04 | 2.0.E−04 |
| | A | B | A | B | A | A |
| Tg (° C.) of cured material | 148 | 185 | 170 | 148 | 200 | 205 |
| Adhesion (MPa) | 7.6 | 5.6 | 6.6 | 7.8 | 5.4 | 3.2 |
| | A | A | A | A | A | B |
| Adhesion (MPa) | 2.3 | 4.6 | 5.0 | 2.2 | 4.9 | 2.7 |
| (In environment at 150° C.) | C | B | A | C | B | C |

| | | | | Comp. |
|---|---|---|---|---|
| | Ex. 13 | Ex. 14 | Ex. 15 | Ex. 9 |
| Naphthalene skeleton-containing | — | 10.0 | 10.0 | 10.0 |
| epoxy resin 1 | | | | |
| Naphthalene skeleton-containing | 10.0 | — | — | — |
| epoxy resin 2 | | | | |
| Glycidylamine-type epoxy resin 1 | 60.0 | 40.0 | 40.0 | 40.0 |
| Glycidylamine-type epoxy resin 2 | — | — | — | — |
| Dicyclopentadiene-type epoxy resin | 25.0 | 40.0 | 40.0 | 35.0 |
| Reactive diluent 1 | 5.0 | 10.0 | — | 15.0 |
| Reactive diluent 2 | — | — | 10.0 | — |
| Imidazole compound 2 | 3.0 | 3.0 | 3.0 | 3.0 |
| Phenolic curing agent | 10.0 | 10.0 | 10.0 | 10.0 |
| Conductive particles | 593.3 | 593.3 | 593.3 | 593.3 |
| Epoxy equivalent (g/eq) of epoxy compound | 117 | 127 | 134 | 125 |
| Content percentage (% by mass) of conductive | 84.0% | 84.0% | 84.0% | 84.0% |
| particles in conductive composition | | | | |
| Specific resistance (Ω · cm) | 2.5.E−04 | 2.9.E−04 | 2.1.E−04 | 1.9.E−04 |
| | A | B | A | A |
| Tg (° C.) of cured material | 164 | 156 | 153 | 141 |
| Adhesion (MPa) | 7.2 | 6.2 | 8.8 | 5.5 |
| | A | A | A | A |
| Adhesion (MPa) | 4.0 | 3.4 | 4.1 | 2.2 |
| (In environment at 150° C.) | B | B | B | C |

From the results shown in Tables 1 to 3, it was found that the conductive compositions of the Examples had excellent conductivity and that the adhesion in the high-temperature environment was also excellent.

Comparative Example 1 is an example in which the imidazole compound content exceeded the upper limit value, and the adhesion in the high-temperature environment was poor.

Comparative Example 2 is an example in which the imidazole compound was not the predetermined imidazole compound, and the specific resistance was poor.

Comparative Example 3 is an example which did not contain any phenolic curing agent, and the specific resistance was poor.

Comparative Example 4 is an example in which the phenolic curing agent content exceeded the upper limit value, and the adhesion in the high-temperature environment was poor.

Comparative Example 5 is an example in which the conductive particle content was less than the lower limit value, and the specific resistance was poor.

Comparative Example 6 is an example in which the content percentage of the glycidylamine-based epoxy resin was less than the lower limit value, and the adhesion in the high-temperature environment was poor.

Comparative Example 7 is an example in which the content percentage of the naphthalene skeleton-containing epoxy resin was less than the lower limit value, and the adhesion in the high-temperature environment was poor.

Comparative Example 8 is an example in which the content percentage of the naphthalene skeleton-containing epoxy resin exceeded the upper limit value, and the adhesion in the high-temperature environment was poor.

Comparative Example 9 is an example in which the reactive diluent content exceeded the upper limit value, and the adhesion in the high-temperature environment was poor.

Regarding various numerical ranges described in the specification, the upper limit values and the lower limit values thereof can be freely combined, and it is considered that all the combinations are described in the present specification as preferable numerical ranges. Moreover, a numerical range “X to Y” means X or more and Y or less.

### REFERENCE SIGNS LIST

1: Tough pitch copper plate
2: Adhesion region
3: Clamped region

1. A conductive composition comprising an epoxy compound, an imidazole compound, a phenolic curing agent and conductive particles,
wherein in the epoxy compound, a content percentage of a naphthalene skeleton-containing epoxy resin is 10 to 30% by mass, a content percentage of a glycidylamine-based epoxy resin is 40 to 90% by mass, and a content percentage of a reactive diluent having one to two glycidylether functional groups in an aliphatic hydrocarbon chain is 10% by mass or less,
the imidazole compound contains at least one selected from the group consisting of 2-undecylimidazole, 2-heptadecylimidazole, 4-methyl-2-phenylimidazole and 2-phenyl-4-methyl-5-hydroxymethylimidazole,
a content of the imidazole compound is three to 10 parts by mass based on 100 parts by mass of the epoxy compound,
a content of the phenolic curing agent is 10 to 20 parts by mass based on 100 parts by mass of the epoxy compound, and
a content of the conductive particles is 82 to 90% by mass in the conductive composition.

2. The conductive composition according to claim 1, wherein a glass transition temperature of a cured material obtained by heating at 80° C. for 30 minutes and then heating at 180° C. for 60 minutes is 150° C. or higher.
